(19) United States
(12) Patent Application Publication
(10) Pub. No.: US 2005/0108540 A1
(43) Pub. Date: May 19, 2005

(54) Digital image validations system (DIVA)

(76) Inventors: Budi Kusnoto, Chicago, IL (US); Yunqing Pan, Oak Lawn, IL (US)

Correspondence Address: THE ECLIPSE GROUP, 10453 RAINTREE LANE, NORTHRIDGE, CA, 91326, US

(21) Appl. No.: 10/949,171

(22) Filed: Sep. 24, 2004

Related U.S. Application Data
(60) Provisional application No. 60/506,564, filed on Sep. 26, 2003.

(51) Int. Cl. H04L 9/00

(52) U.S. Cl. 713/176; 713/165

(57) ABSTRACT

The DIVA stands for Digital Imaging Validation: is an external electronic device equipped with controlled microprocessor, which includes write protection, data encryption, and duplication capabilities. This electronic device is equipped with flash memory chips to hold/store digital image data produced by any digital imaging devices. This electronic device is packaged in small form factor housing (including compact flash form, dongle form, PCMCIA form etc) with abilities to act as storage memory device of the digital imaging device and can be directly inserted or attached to the interface port of the corresponding imaging device. The DIVA is also known as Programmable Microprocessor-Integrated Encryption External Storage Media. Furthermore, DIVA is also comprises of a system utilizing secured web-based application to deploy its full capability.

### RELATED APPLICATIONS

U.S. Provisional Patent Application No. 60/506,564, filed on Sep. 26, 2003, entitled “DIGITAL IMAGE VALIDATION SYSTEM (DIVA)”, by Budi Kusnoto and Yunqing Pan, which a claim to priority is made and is incorporated by reference herein.

### BACKGROUND OF THE INVENTION

1. Field of the Invention

The invention relates generally to digital programmable memory and more specifically, to validation of data stored in programmable memory.

2. Related Art

Digital cameras and other digital imaging devices (such as digital x-ray machines, digital laser scanners) are able to take photographs/images of subjects and store them as data using a digital image formats such as .JPG, .TIFF, .RAW, etc. However, with today's image editing software, it is not difficult to make changes to those digital images. The changes may be so realistic that they become indistinguishable by human eyes. It is possible; such changes in digital images may be used illegal purposes such as insurance fraud, or, to provide fake evidence in a legal matter. Various technologies solutions, either hardware or software solutions, have been presented in the past to prevent such changes to digital images.

Known approaches for protecting digital image data include: Image meta-data. Digital camera manufacturers first developed “meta-data” (so-called EXIF). The meta-data is header information stored in the digital image file to identify the picture taking conditions and camera settings, such as camera model, ISO, shutter speed, aperture number, white balance, etc. The meta-data header is supposed to be destroyed if there is any change to the digital image. However, since the meta-data is open source header information, anyone who has some computer science knowledge can easily access and modify the meta-data contained in the digital image. Thus, the meta-data may be easily preserved or modified to mask changes that are made to the digital image.

In another approach, digital signature and watermarking are used. A number of companies and research institutes have developed digital signature or watermarking algorithm. Once the author “signs” or “watermarks” their digital images by embedding encryption code into them, other people can no longer change the images without the authorization, usually in forms of key or password. However, these are solely based on software to protect the copyright of digital images. If utilized to protect authenticity, the shortcoming becomes very obvious, since the signature and watermarking can be added to at any time no matter if the image has been tampered with or not.

In yet another approach, secure digital imaging device and secure memory card are used. This technology requires a person to buy the specific camera that produces protected image data on a specific secure memory card. With this combination, once the images have been taken and stored on the memory card, nothing further can be done to them. However, some basic modifications such as resizing, tilting, changing color depth (as well as brightness and contrast adjustment), might still be needed, especially when people want to publish the pictures. Also, people may not want to throw away their digital cameras to buy a new one with actually less usability because of a proprietary image security approach. Thus, focus of such approaches is to guard the content of those images and its interpretation, not so much on the quality.

Therefore, there is a need to address the difficulties set forth above and others previously experienced.

### SUMMARY

A method and system that provides special coding done in the hardware parts of memory in order to prevent interception of the data before the data is encrypted by providing two copies of a digital image, with one of the digital images being a modifiable original file and the another digital image being a validation file. The original digital image is exactly what the camera's processor generates. The modified copy is one that is compressed and encrypted from the original image based on compression technique. The encrypted-compressed files can only be opened using a unique software or hardware decoder that may not generally be available to public. Any changes to the file, even single bit reversal, results in validation to fail.

### DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 illustrates a digital image validation system in a Compact Flash small form factor.

FIG. 2 illustrates a core processor unit of the digital image validation system shown in FIG. 1.

FIG. 3 illustrates another implementation of the core processor unit of FIG. 2 embedded in a Dongle form factor.

FIG. 4 is a flow diagram of the monitoring data traffic and firmware update for the digital image validation system of FIG. 1.

FIG. 5 is a flow diagram of decryption of digital images stored in the compact flash of FIG. 1. FIG. 6 is a diagram of an application for remote digital image validation and firmware update.

### DETAILED DESCRIPTION

Systems and methods to secure digital images or data consistent with the present encryption external storage medium may be adapted to permanent and removable memory or similar media, such as CompactFlash™, Smart Media™, or similar shaped housing or other small form factor housing (such as dongle key, PCMCIA, controller integrated memory devices, etc). Such memory commonly used by digital cameras but may be used in other image generating/obtaining digital devices (such as digital radiography, CT-Scan, Digital Video, etc). The current embodiment will use a CompactFlash™ shape that complies with the specifications of both CF/CF+ card and digital camera data interface as set forth by CFA (CompactFlash Association) and JEIDA (Japan Electronic Industry Development Association).

Other embodiments may also be implemented/manufactured in different small form factor that will give more freedom in shapes, adaptabilities and functions such as powered by external/internal power source such as USB port/SCSI port or other connections that can also be used as a power source. Further development and application of embodiments of the invention may enable different kinds of devices that produce digital image data to share or use removable memory while securing the digital images contained on the media. Compression function can be embedded as well as the encryption function to preserve more spaces.

The current embodiment may fit into a digital camera's compact flash card adaptor or any other digital imaging device using compact flash memory as storage media. In other embodiments, other types of removable memory media may be employed. The hardware may be a Compact Flash card (in both type I and type II). As described in the CF+ and Compact Flash Specification Revision 1.4, a CF or CF+ card may have a controller processor(s) between the host interface and the I/O modules. In the current embodiment, the validation, encryption and duplication tasks may be done in the controller processor. Also the host interface for reading and writing will be 100% compliant with the Specification that may be controlled by the controller processor.

Every digital image validation system card is equipped with a unique serial number and encryption technology, such as a 40, 56, 64, and 128-bit encryption key and other encryption keys that may utilize either security key or public key methods. In another embodiment, identical public key method may be utilized by assigning identical key to every card. The serial number is simply a manufacturer item control number and is available to everyone, e.g. “S/N: EC0000001” printed on the cover/casing of the small form factor.

The encryption key may be used to perform the encryption of image data. The encryption may conform to public and/or security key algorithm such as Rivest, Shamir, Adleman (RSA) algorithm (public key based), Data Encryption Standard and/or Advanced Encryption Standard (security key based) as set forth by NIST (National Institute of Standards and Technologies). The encryption key may be built into the chip so that users have no access to it. It may be preferable, that only the manufacturer knows the corresponding encryption key to each individual card, which is stored in a secure database on a digital image validation system server site.

Upon encryption, the binary data may undergo data compression utilizing deflate or other similar compression algorithm. The memory card with digital image validation system is available for writing information only when it's residing in a camera and the camera is in the picture-taking mode. Thus only the original data directly coming from the camera processor will be written onto it. This may be done through the communication between the camera and the core processor.

According to JEIDA's (Japan Electronic Industry Development Association) digital camera specification documents, each time when a camera is powered on as picture-taking or picture-viewing, it will first check whether the desired file system is present in the memory storage media. The file system may be ROOT/DCIM/AAAA#### (‘A’ stands for any upper-case letter, and ‘#’ stands for any number from 0-9). If the folder is not there, the Writer/Reader will create one on it. There will be no specific file system checking when a memory card is working in either a universal card reader or the camera memory slot as the camera is in universal serial bus (USB) transmission mode.

So each time when the DIVA card is powered on, it will be waiting for the folder-locating signal from its interface before it disables the write protector. Once the card receives the signal, write protection will be disabled to allow the image data to be written until the next power off. When the image data flow through, the duplicator module in the controller will start to function. While writing the image data on the storage module, it makes a duplicate onto its own buffer. Then the compressor-encryptor takes the image in the buffer, uses the encryption key to encrypt it into the DIV file format, and then stores it onto the memory.

When transferring data out from the memory card, the user just plugs the DIVA card into a universal card reader and performs normal copy-and-paste to all the files, including both original and verified files. Since erasing files or formatting The DIVA card requires information to be written on to the storage media, this task can only be done in the camera using the camera's default erase/format options.

The DIVA core processor may be a microprocessor, digital signal processor, discrete logic or analog circuits that implement a state machine, application specific integrated circuit (ASIC), or a combination of the above. The only difference is DIVA will need small background application to monitor flow of data from and through the image captured hardware peripheral connected directly to CPU via PCMCIA/SCSI/Parallel/Serial/USB/Firewire or other type of connections.

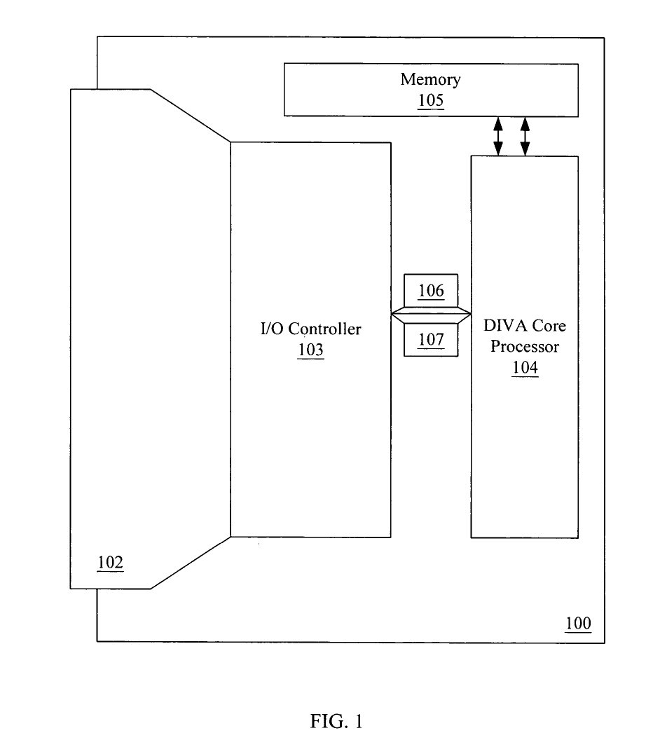

Turning to FIG. 1, a digital image validation system in a Compact Flash small form factor 100 is illustrated. The compact flash form factor 100 has a standard Compact Flash dimension (42×36×3.5 mm) or in other embodiments other Form Factor Housing such as dongles/PCMCIA/other embodiment with various connector type such as SCSI, Parallel, Serial, USB, Firewire, may be employed. Standard Compact Flash Standard I/O connector is a 50 Pin connector 102 located along an edge of the Compact Flash. The form factor 100 may also have an I/O controller 103 coupled to the connector, digital image validation core processor 104, memory 105, and buffers 106 and 107. Image data is received from a device at the connector 102 via the I/O interface controller 103 and passed through channels 106 and 107 to the DIVA core processor 104 for processing. The image data is then stored or retrieved from memory 105 by the DIVA core processor. In other embodiments, the blocks representing processors and controllers may be combined or further broken down by function.

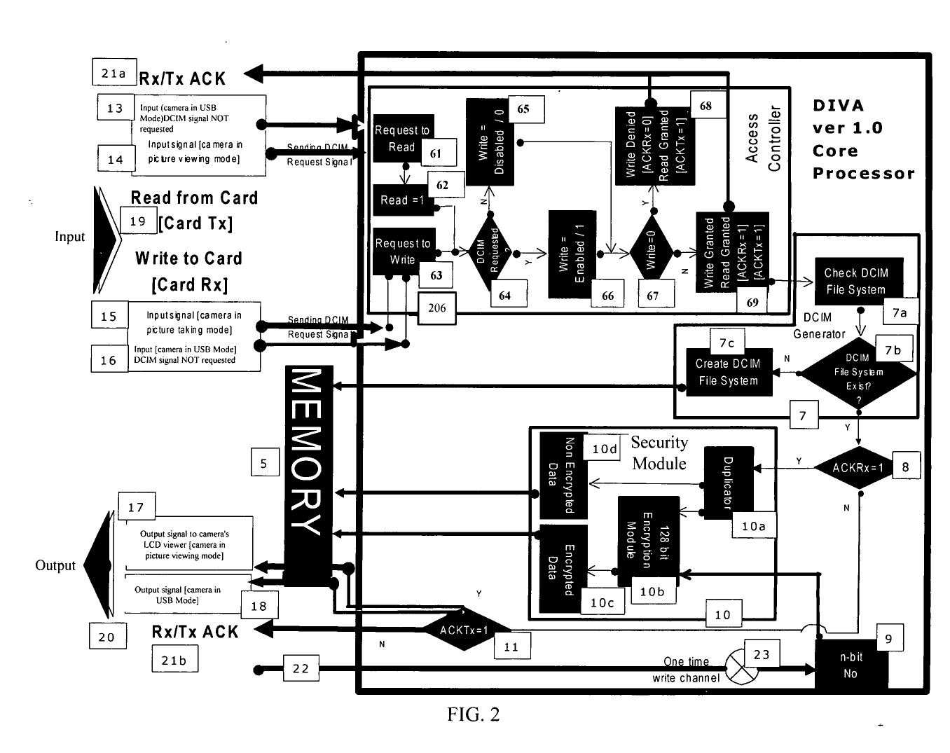

In FIG. 2 a core processor unit 104 of the digital image validation system of FIG. 1 is shown. The DIVA Access Controller 206 grants or denies writing access to the memory 105 based on criteria. The READING of information/data stored in the memory 105 requires the Input PIN from I/O Interface Controller 103 send signal requesting authorization to begin READING data from memory 105.

When a digital device such as a digital camera is set to be in picture viewing mode 14, the camera will send DCIM request signal [DCIMRS] to this PIN, otherwise no DCIMRS may be sent, such as signal requested by USB mode 13. The I/O Controller 103 through channel 106 to the DIVA Core processor 104 may patch input signals from 13, 14, 15 and 16. The DIVA Access Controller 206 may then grant a READ.

The WRITING of information/data to the memory 105 occurs when the input PIN from I/O Interface Controller 103 sends a signal requesting authorization to begin WRITING data to memory 105. The request may come from a camera in picture taking mode 15 or USB mode 16. When the signal comes from the camera in picture taking mode 15, the DCIMRS will be sent, otherwise no DCIMRS is sent. The I/O Interface Controller 103 will perform checking of the DCIMRS. Upon receiving DCIMRS, WRITE access will be granted (WRITE=Enabled/1) 66, otherwise WRITE will not be granted (WRITE=Disabled/0).

In order for to be WRITE to be enabled, i.e. for WRITE=Enabled/1, the WRITE status must be checked. If WRITE access=Enabled then process will go to 69, otherwise process will go to 68. The WRITE denied, ACKRx=0 21a then the ACKNOWLEDGE RECEIVING signal to the I/O Interface Controller 103 is disabled. If READ is granted, ACKTx=1 21a is enabled and the ACKNOWLEDGE TRANSMITTING signal to the I/O Interface Controller 103 is present. Granting both WRITE and READ requires that both ACKRx 21a and ACKTx 21a value will be 1 (enabled).

The core processor 104 will check the existence of DCIM file system in the memory 105 upon a request being sent by process 14 and 15 after being checked and granted by the Access Controller 206. If the DCIM file system already exists in memory 105 then ACKRx is enabled, or set to 1, otherwise a DCIM file system is created. Creation of DCIM File System and writing to the DCIM File System to the memory 105 requires the ACKRx signal 21a. If the ACKRx signal is enabled (i.e.=1), then process may continue to the security module 10, otherwise ACKTx=1 11.

Each DIVA card, Compact Flash card in the present embodiment, may have CMOS memory cells containing n-bit unique serial number (S/N) that is unique for each DIVA card. The n-bit S/N was stored during manufacturing of the processor by mean of writing the n-bit S/N data 22 through one time write channel 23. In other embodiments, other permanent memory method may be employed. The Security Module 10, may consist of a Duplicator 10a. The Duplicator 10 makes copy of every bit of signals received. The copy of the data generated by Duplicator 10a is passed through the Encryption module 10b, which received the encryption code from 9. The Encryption module 10b create encrypted data 10c. The original data is then passed directly to non-encrypted data output 10d from the Duplicator 10a.

The ACKTx value 21a generated by the Access Controller 106 controls execution of the security module. If ACKTx=1 is enabled, then the reading of data from the memory 105 through channel 17 for output to digital camera LCD viewer OR channel 18 for output to USB mode (USB Channel), otherwise ACKTx=1 11 will return the ACKTx value to the system 21b. Both channel 17 and 18 will output through the output channel 107 to the I/O Interface Controller 103.

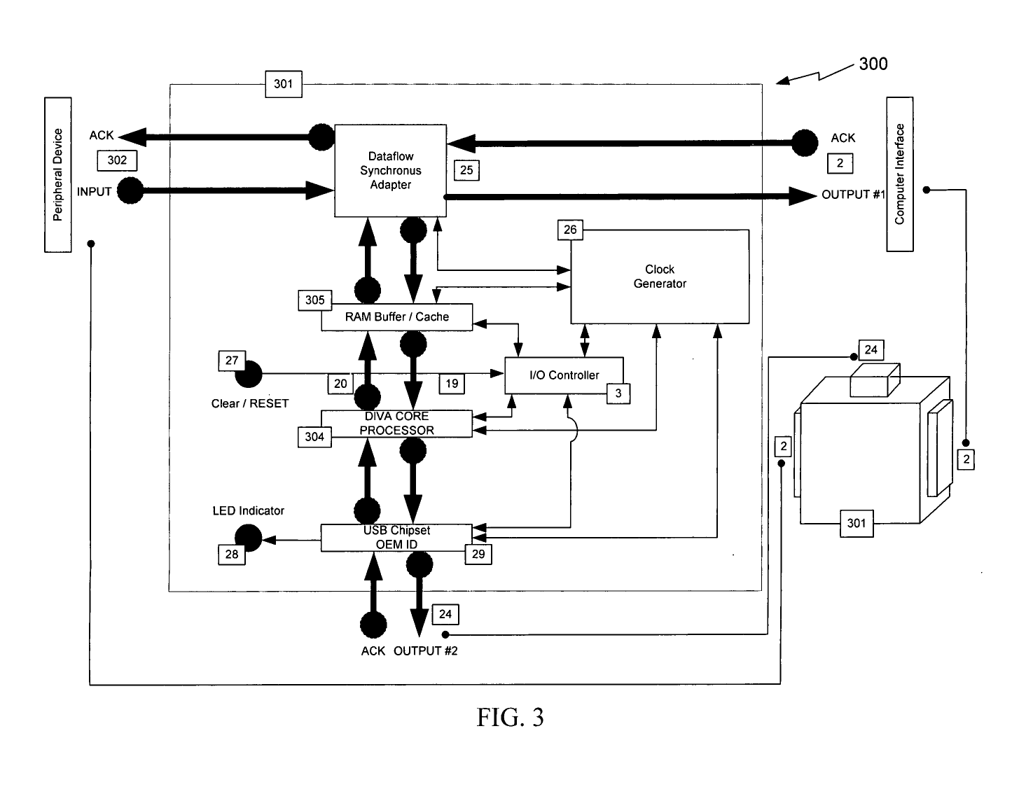

Turning to FIG. 3, another implementation of the core processor unit of FIG. 2 embedded in a Dongle form factor 301 is illustrated. The Dongle may also have one or more connectors 302 for connecting the Dongle to electronic devices. An I/O controller 303 interfaces between the connector 302 and the different interfaces 302 and 24 via miscellaneous circuitry including a DIVA core processor 304 and RAM buffer/cache 305.

The secondary output channel 24 (could be as USB, SCSI, Firewire etc) acts to pass the encrypted copied data as a result of DIVA core Processor to other storage media (such as hard drive of a CPU where this other embodiment of DIVA was attached). The dataflow synchronous adapter 25 is used to synchronize data flow between the pass through of the primary output channel (original data 502) and data that will be processed/encrypted at a DIVA core processor 504.

The current implementation of DIVA for imaging peripheral devices may operate at high speed in order to handle and process massive data such as CT-scan or other 3D imaging. A clock generator 26 generates timing signals that are used to synchronize all processes especially for self-powered embodiments.

In some implementations, a Clear/RESET button 27 may function to clear memory/buffer such that erasing the data can not be done externally and a ready LED indicator may be employed to indicate when the dongle is at work (green), busy (blinking green) or not working (red). Furthermore, an OEM ID Chipset may store unique information as well as have a controller to link the DIVA card to software driver. This unique information may later be used as by firmware updates to upgrade the DIVA card security/encryption key as well as encryption algorithm.

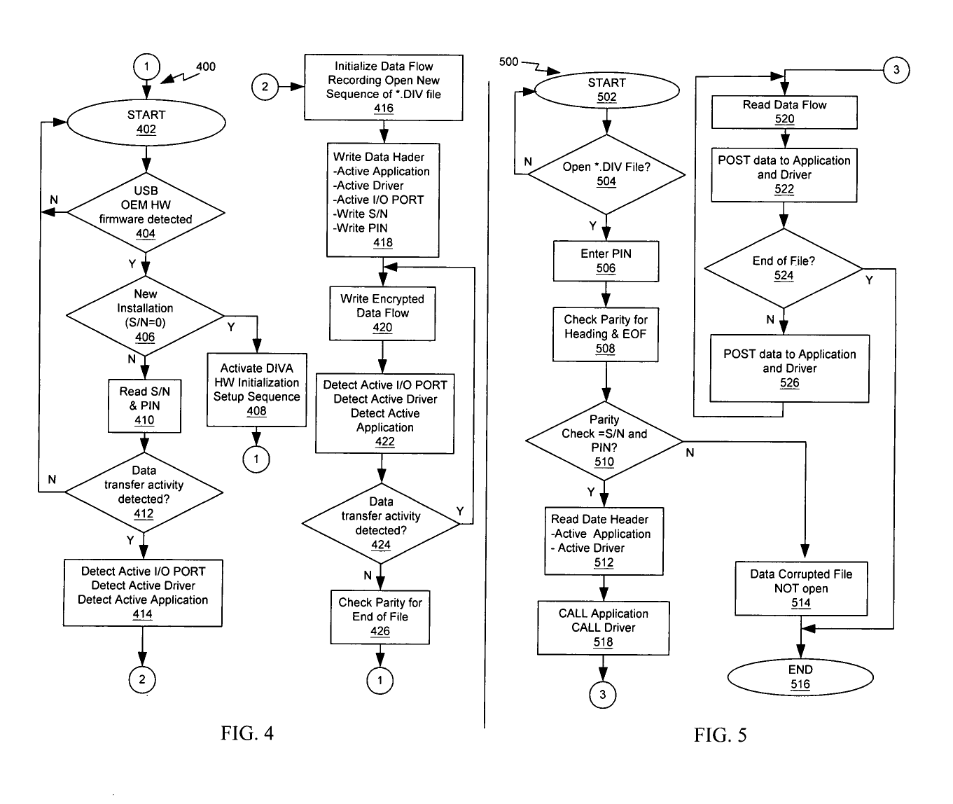

Turning to FIG. 4, a flow diagram 400 of the monitoring data traffic and firmware update for the digital image validation system of FIG. 1 is shown. The flow starts 402 with the USB OEM H/W firmware being detected 404. If the USB OEM H/W firmware is detected 404, then a determination is made as to a new installation 406. Otherwise, processing starts again 402.

If a new installation is detected 406, then DIVA H/W initialization setup sequence is activated 408. Otherwise, the serial number and pin are read 410. If data transfer activity is detected 412, then the active I/O Port, Active Driver and Active Application are detected 414. Otherwise if the data transfer activity is not detected 412, then the process starts 402.

After step 414, then the data flow recording is initialized as an OpenNew Sequence of *.DIV file 416. The data header is written 418 and the encrypted data flow is written 420. The active I/O PORT, active Driver, Active Application is once again detected 422. If data transfer activity is detected 424, then the encrypted data is again written 420. Otherwise data transfer activity is not detected 424 and a parity check for the end of file is conducted 426.

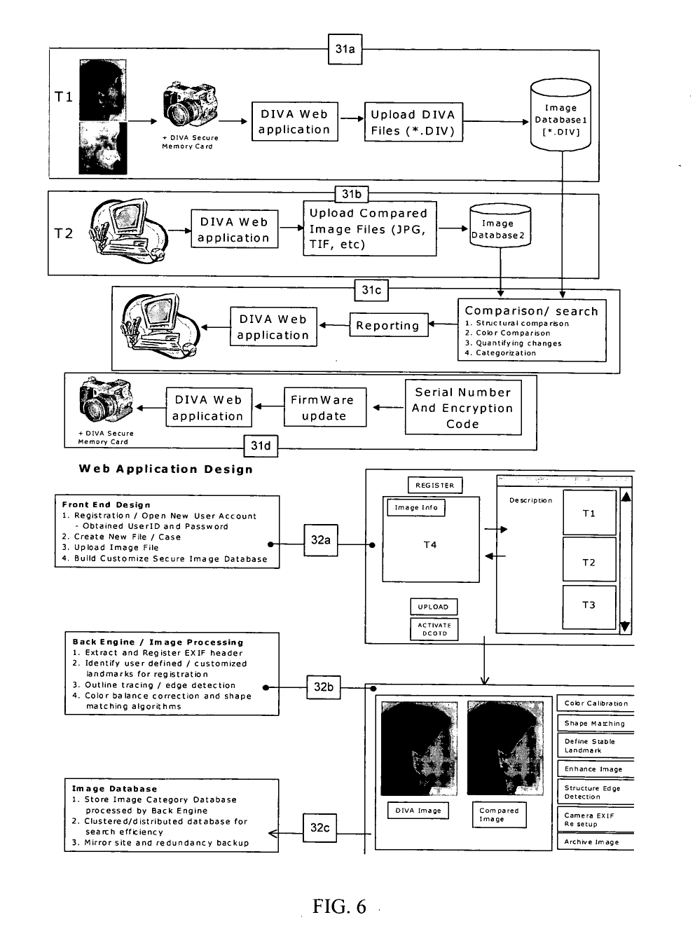

In FIG. 5, a flow diagram 500 of decryption of digital images stored in the compact flash of FIG. 1 is shown. The flow diagram 500 starts 502 with an attempt to open a .DIV file 504. If the DIV file cannot be open, then the process starts again 502. Otherwise, a PIN number is entered 506 and a check of parity for heading and end of file (EOF) is conducted 508.

If the parity check equals the serial number and pin 510, then the data header, active application, and active drive are read 512. Otherwise the data is determined to be corrupt and the file is not opened 514 and the process is ended 516.

After the data headers, active applications and active driver are read 512, calls are made to the application and the drivers occur 518 and the data flow is read 520. The decryption algorithm is activated 522 and the data flow is processed until the end of file 524. If the end of file is reached, then processing is complete 516. Otherwise 524, data is posted to the application and driver 526 and the data flow is read 520.

Turning to FIG. 6, that figure shows DIVA web application 31a allowing users to upload and decode the encrypted digital file generated by DIVA hardware/device as well as updating the hardware firmware in certain embodiment of the DIVA hardware implementation. The DIVA web application 31a and its secured channel and server accepting encrypted digital image data generated by digital image captured hardware peripheral (camera, scanner etc). The uploaded encrypted files (*.DIV) are being stored in the “Image Database 1.” The DIVA web application 31b may be utilized to perform comparison of an image to the encrypted “original” DIVA image stored in DIVA secured server database (Image Database 1). This digital image will be stored for process in “Image Database 2.” The DIVA server 31c may have a built-in image comparison algorithm which can performed but not limiting to the following tasks: structural comparison, color comparison, quantifying changes and image categorization/databasing).

In certain embodiment of DIVA hardware implementation (such as in dongle key etc), the DIVA web server may also provide a firmware update via a firmware update module 31d allowing DIVA web server to remotely update encryption algorithm on the DIVA hardware as well as serial number/PIN/encryption key. This feature will be useful to fight against constant effort to penetrate DIVA hardware encryption code by “hackers”.

DIVA web application GUI (Front End) design 32a, allows users to register, upload DIVA files and compared images with DIVA files previously uploaded in the DIVA secured database. DIVA web application back engine 32b, composed mainly but not limiting to store and analyze EXIF header of digital images, image processing, structural and color changes detections. Statistical analysis may also be reported based on the finding of the engine 32b. The Image databases 32c (Image Database1 and Image Database2), see 31a and 31b for details and functionality store image category database processed by the DIVA web application back engine 32b and a clustered/distributed database for search efficiency and a mirror site and redundancy backup.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, the described implementation includes software but the invention may be implemented as a combination of hardware and software or in hardware alone. Note also that the implementation may vary between systems. The claims and their equivalents define the scope of the invention.

Other systems, methods, features and advantages of the invention will be or will become apparent to one with skill in the art upon examination of the following figures and detailed description. In another embodiment of this invention, the DIVA server application may also act to update the Firmware embedded in the DIVA secure memory card to update either it's encryption algorithm, security key or unique encryption key. It is intended that all such additional systems, methods, features and advantages be included within this description, be within the scope of the invention, and be protected by the accompanying claims

1. An storage medium that stores digital data, comprising:
a input/output controller;
a memory; and
a digital validation processor coupled to the input/output controller and memory where the digital validation processor modifies the digital data stored in the memory.

2. The storage medium of claim 1, where the digital validation processor further includes:
a duplicator that creates duplicate digital data that is stored in the memory; and
an encryption module that modifies at least one of either the digital data and the duplicate digital data.

3. The storage medium of claim 3, where the modified one of the digital data and the duplicate digital data is encrypted prior to storage in the memory.

4. The storage medium of claim 2, where the encryption module employs a 128 bit encryption algorithm.

5. The storage medium of claim 2, further including:
a connector coupled to the input/output controller that is adapted to connect to a digital imaging device.

6. A digital image validation system, comprising:
a storage medium with a duplicator that creates a duplicate digital data set from a digital data set with the duplicate digital data set being encrypted; and
a web server executing a web application that is capable of receipt of the duplicate digital data set from the storage medium, where the web application validates the duplicate digital data.

7. The digital image validation system of claim 6, where the web application further includes:
an encryption module that decrypts the duplicate digital data; and
a comparison algorithm that compares the duplicate digital data with the digital data set when the web application is in receipt of the data set.

8. The digital image validation system of claim 7, where the comparison algorithm makes at least one comparison of either color, structure, or image categorization.

9. The digital image validation system of claim 6, where the web application further includes:
a programmable memory in the storage medium; and
a firmware update module that changes the programmable memory in the storage medium.

10. The digital image validation system of claim 9, where the programmable memory stores at least one of a serial number and an encryption code.

11. A method of storing digital data, comprising:
receiving digital data at a storage medium device;
duplicating the digital data to create duplicate digital data;
encrypting the duplicate digital data; and
storing both the digital data and the duplicate digital data in memory.

12. The method of claim 11, where encrypting further includes:
applying a 128 bit encryption algorithm to the duplicate data set.

13. The method of claim 11, where the storage medium includes:
connecting the storage medium to digital imaging device via a detachable connector.

14. A method of digital image validation, comprising:
receiving digital data at a storage medium device;
duplicating the digital data to create duplicate digital data;
encrypting the duplicate digital data into encrypted digital data;
storing both the digital data and the encrypted digital data in memory;
transmitting the encrypted digital data to a server;
transmitting the digital data to the server;
decrypting the digital data at the server into the duplicate digital data; and
comparing the digital data to the duplicate digital data.

15. The method of claim 14, where decrypting further includes:
applying a 128 bit encryption algorithm to decrypt the encrypted digital data into duplicate digital data.

16. The method of claim 14, further including:
updating the firmware in the storage medium via the server.

17. The method of claim 14, where the comparing further comprises:
comparing the structure of the digital data with the duplicate digital data.

18. The method of claim 14 where the digital data is digital image data.

19. The method of claim 14 where the server is a World Wide Web server.

20. The method of claim 14 where the storage medium is in a compact flash form.
